(19) United States
(12) Patent Application Publication
(10) Pub. No.: US 2014/0130677 A1
(43) Pub. Date: May 15, 2014

(54) AIR FILTERING DEVICE IN AN AIR INTAKE LINE OF AN INTERNAL COMBUSTION ENGINE

(71) Applicant: MGI COUTIER, Champfromier (FR)

(72) Inventors: Pascal GUERRY, Seppois-le-haut (FR); Adrien EUSTACHE, Nantua (FR); Max VAREON, Chatillon en michaille (FR)

(73) Assignee: MGI COUTIER, Champfromier (FR)

(21) Appl. No.: 14/014,438

(22) Filed: Aug. 30, 2013

(30) Foreign Application Priority Data
Aug. 30, 2012 (FR) 12/58126

(51) Int. Cl. F02M 35/14; F02M 35/024; F02M 35/022; F02M 35/02; F02M 35/12

(52) U.S. Cl. CPC F02M 35/14; F02M 35/0216; F02M 35/1272; F02M 35/0226; F02M 35/02416
USPC 96/383; 55/320; 55/331

(57) ABSTRACT

A filtering device including an inlet orifice, an outlet orifice, and a housing, the housing including an inlet compartment and a filtering element arranged in the housing between the inlet compartment and the outlet compartment so as to filter the flow of air, where the filtering device includes a deflector arranged in the inlet compartment and opposite the inlet orifice so as to deflect the flow of dirty air penetrating into the inlet compartment.

### TECHNICAL FIELD

The present invention relates to a filtering device for filtering a flow of air in an air intake line of an internal combustion engine. The present invention is used, in particular, in the automotive field to equip an internal combustion engine of a motor vehicle.

### BACKGROUND

FR2905425A1 discloses an air filter for an internal combustion engine comprising a housing having an inlet orifice for dirty air, an outlet orifice for filtered air and a filter cartridge arranged in the housing between the inlet orifice and the outlet orifice so as to filter the dirty air. Moreover, the air filter comprises an angled inlet conduit to separate the water contained in the dirty air.

An air filter is used to filter solid and/or liquid particles. The solid particles contained in the dirty air may be of any type, for example of the metal, organic, mineral type, etc. The liquid particles contained in the dirty air are generally rainwater drawn in by the internal combustion engine during operation. However, the liquid particles may be of any type.

However, the inlet conduit conducts the majority of the dirty air toward a central region of the filter cartridge which causes rapid clogging of said central region. The filter cartridge thus has a relatively short service life. Moreover, the angled inlet conduit has a relatively large overall footprint or space requirement which runs the risk of not being suitable for a small engine compartment.

### BRIEF SUMMARY

The invention remedies totally or partly, the aforementioned problems.

To this end, the subject of the invention is a filtering device for filtering a flow of air in an air intake line of an internal combustion engine, the filtering device comprising:
an inlet orifice designed for the passage of a flow of dirty air which may be laden with solid and/or liquid particles;
an outlet orifice designed for the passage of a flow of filtered air;
a housing comprising i) at least one inlet compartment into which the inlet orifice opens, and ii) at least one filter, such as a filter cartridge, arranged in the housing between the inlet compartment and the outlet orifice so as to filter the flow of air which flows into the housing between the inlet orifice and the outlet orifice;

wherein the filtering device further comprises a deflector arranged in the inlet compartment and opposite the inlet orifice so as to deflect the flow of dirty air penetrating into the inlet compartment.

In other words, an obstacle is placed transversely to the principal direction of the flow of dirty air penetrating into the housing, so as to deflect said flow of dirty air to distribute it substantially uniformly over the entire surface of the filtering element.

Thus, such a deflector makes it possible to reduce the air speeds in the inlet compartment and in the vicinity of the filtering element, which reduces the depth of penetration of the particles in the filtering element and thus increases the service life of the filtering element.

Moreover, such a deflector makes it possible to reduce the overall loss of pressure generated by the filtering device during operation, relative to a device of the prior art. More specifically, even if the deflector generates a slight loss of pressure locally, on the one hand, the deflector makes it possible to distribute the flow of dirty air more uniformly over the entire surface of the filtering element. On the other hand, the deflector prevents the occurrence of burbling or limits the degree of burbling in the flow of dirty air upstream of the housing and at the inlet of the housing.

Preventing or limiting the occurrence or degree of burbling of the flow of air upstream of the housing and at the inlet of the housing also permits noise caused by the flow of dirty air to be reduced, in particular when the flow rate is high, as burbling of the flow of air would cause whistling which would disturb the driver. The deflector opposes the pressure waves which originate from the engine which makes it possible to reduce the noise of the engine and the transmission thereof along the air intake line. It has been observed that the deflector reflects the pressure waves originating from the internal combustion engine, on the side opposing the flow of air, which makes it possible to limit the burbling or turbulence of the flow of air in the region of the inlet orifice, in particular for frequencies ranging between 500 Hz and 1000 Hz approximately.

According to an embodiment, the surface area of the greatest cross section of the deflector, measured substantially parallel to the inlet orifice, is greater than the passage cross section defined by the inlet orifice.

In other words, the deflector masks the inlet orifice to an observer positioned in front of the inlet orifice between the deflector and the filtering element. Projected in a plane perpendicular to the principal direction of the flow of dirty air passing through the inlet orifice, the surface area of the deflector is greater than the surface area of the inlet orifice.

Thus, such a deflector deflects all the lines of the flow of dirty air which reduces the speeds of said flow of air in the inlet compartment and in the region of the filtering element.

According to a variant of the invention, the inlet orifice is generally planar. Alternatively, the inlet orifice may be defined by a curved surface.

According to an embodiment, a deflection ratio denoted L/D ranges between 0.05 and 1.5, preferably between 0.1 and 1, where:
L is the distance between the inlet orifice and said greatest cross section of the deflector;
D is a transverse dimension of the inlet orifice.

Thus such a deflection ratio improves the distribution of the flow of dirty air over the entire surface of the filtering element.

According to an embodiment, the deflector comprises:
an envelope which defines a cavity and which has, on the side of the inlet orifice, at least one collection hole extending through the envelope so as to permit the penetration into the cavity of droplets formed by the water contained in the flow of dirty air; and
a water discharge conduit which is in fluidic communication with the cavity and which extends at least as far as a wall forming part of the housing, so as to discharge, preferably by gravity, the water which has penetrated into the cavity.

Thus, such a cavity permits to collect the water which has been separated from the flow of air by the deflector. As the deflector bends all the lines of the flow of dirty air, the water from the flow of dirty air may be effectively separated from the air. The filtering device may thus fulfill a “decantation” function to separate the water contained in the dirty air and then to discharge said water. Thus, during operation, the filtering element remains dry which increases the service life thereof.

According to an embodiment, the deflector has, on the side of the filtering element, at least one low-pressure bringing hole which extends through the envelope so as to place in fluidic communication the cavity and a calming zone of the housing, said calming zone extending at least into the deflector.

In the present application, “calming zone” is understood as a zone in which the air speeds are less than 3 m/s, preferably less than 2 m/s. Thus, such a low-pressure bringing hole permits the cavity to be placed under low pressure.

According to an embodiment of the invention, the deflector comprises a deformable membrane which is linked to the envelope and which is arranged so as to define a part of the cavity, the deformable membrane preferably supporting a vibrating mass.

Thus, such a deformable membrane makes it possible to dampen air vibrations and thus to reduce the noise originating from the operation of the engine or “vent” noise. If required, the deformable membrane and the vibrating mass form a resonator in which the vibrating mass contributes to the dampening of the air vibrations.

According to a variant of the invention, the membrane, with or without the vibrating mass, is arranged opposite the flow of dirty air which originates from the inlet conduit.

According to an embodiment, the thickness, the surface area and the material of the deformable membrane are selected so as to dampen air vibrations which have a frequency ranging between 30 Hz and 250 Hz, preferably between 50 Hz and 150 Hz.

Thus, such a deformable membrane makes it possible to dampen low frequency vibrations.

According to an embodiment of the invention, the deformable membrane is composed of a viscoelastic material which is preferably selected from the group consisting of elastomers.

Thus, such a material provides the deformable membrane with a non-linear behavior, i.e. variable in frequency, which makes it possible to dampen effectively the air vibrations over the frequency range emitted by the heat engine during operation.

According to an embodiment, the filtering device also comprises an inlet conduit opening into the housing on the inlet orifice, the inlet conduit having a shape which diverges according to the direction of flow of the flow of dirty air, the diverging shape preferably being frustoconical.

Thus, such a diverging inlet conduit contributes to reducing the speed of the flow of air which flows through the inlet orifice. Moreover, it contributes to avoiding or reducing the generation of burbling in the flow of air in the compartment and thus the overall loss of pressure generated by the filtering device during operation.

According to an embodiment, the inlet conduit is arranged substantially in front of the central region of an upstream surface of the filtering element.

In other words, the inlet conduit is arranged symmetrically relative to the filtering element.

Thus, such an arrangement of the inlet conduit relative to the filtering element makes it possible to distribute the air flow rate uniformly toward the filtering element.

In the present application, the terms “upstream” and “downstream” refer generally to the flow of the airflow passing through the filtering device, i.e. a direction generally oriented from the inlet orifice toward the outlet orifice.

According to an embodiment, the deflector comprises:
an upstream portion which generally has the shape of a cone and which extends wholly or partially in the inlet conduit, the axis of the cone preferably being substantially parallel or coaxial with the principal direction of the flow of dirty air in the inlet conduit; and
an downstream portion which extends into the inlet compartment and which has a greater cross section than the base of the cone, measured in a plane perpendicular to the axis of the cone.

In other words, the deflector has the shape of a nail, the point thereof being the cone-shaped portion and the head thereof being the downstream portion.

Thus, such a deflector makes it possible to limit the generation of burbling in the flow of air upstream of the inlet orifice, i.e. the total loss of pressure generated by the filtering device during operation.

In the present application, the “principal direction” of a flow of air corresponds to the average direction in said flow of air when in turbulent flow. Said principal direction is determined by the geometry of the ducting in which said flow of air flows.

According to an embodiment, the cone has a half-angle at the apex which is less than or equal to 7 angular degrees.

Thus, such a half-angle at the apex makes it possible to distribute the flow of air at a limited speed over a greater surface area of the filtering element, which makes it possible to increase the service life or the dust-absorbing capacity of the filtering element.

The half-angle at the apex is an angle formed between the axis of the cone and a generatrix of the cone.

According to an embodiment, the deflector has, i) on the side of the inlet orifice, an upstream surface which is generally planar, and ii) on the side of the filtering element, a downstream surface which is preferably generally planar, the deflector preferably having a lateral surface which is cylindrical and which extends between the upstream surface and the downstream surface.

Thus, such a deflector provides a large upstream surface for the impact of water droplets, which makes it possible to separate effectively the water from the flow of dirty air.

According to an embodiment, the shape of the deflector is generally planar, preferably disk-shaped.

Thus, such a shape of the deflector makes it possible to limit the overall footprint or space requirement of the deflector.

According to an embodiment, the thickness of the deflector, measured perpendicular to said upstream surface, is not insignificant relative to the length of the deflector measured parallel to said upstream surface.

Thus, such a shape of the deflector makes it possible to create a cavity in the deflector.

The aforementioned embodiments of the invention and the variants of the invention may be considered individually or in any combination which is technically possible.

### BRIEF SUMMARY OF THE INVENTION

The present invention will be clearly understood and the advantages thereof will also emerge by reading the following description, provided solely by way of non-limiting example and made with reference to the accompanying drawings, in which:

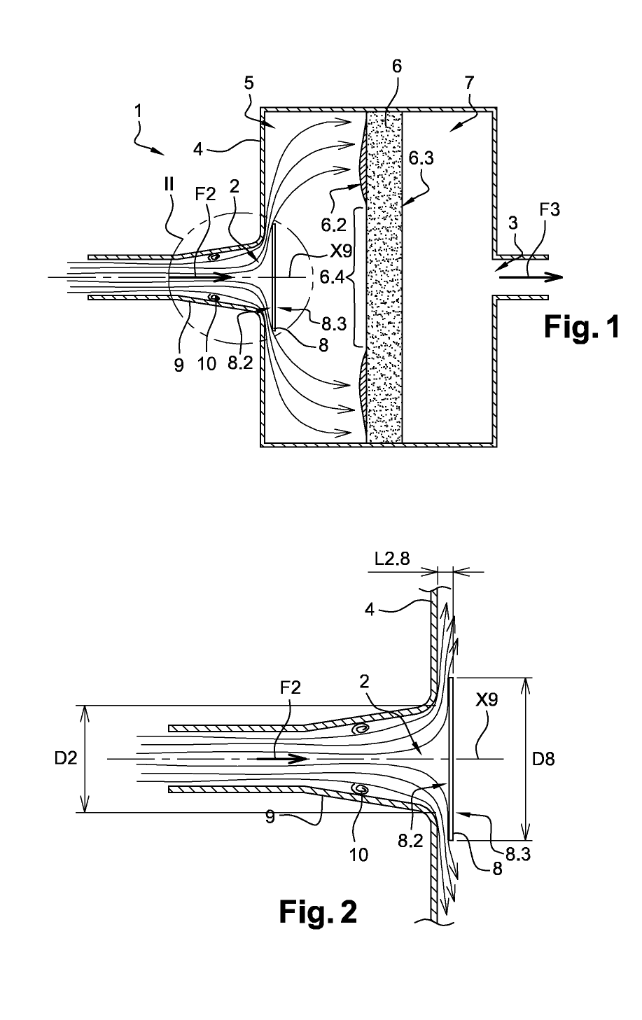

FIG. 1 is a sectional view of a device according to a first embodiment;

FIG. 2 is a view in larger scale of the detail II in FIG. 1;

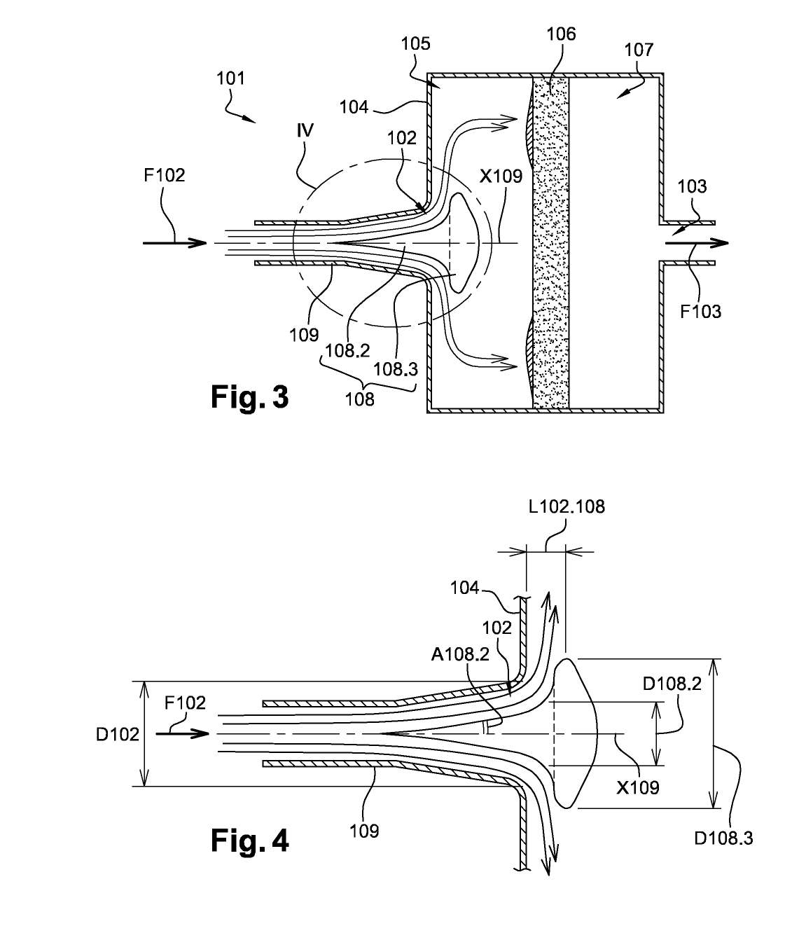

FIG. 3 is a view similar to FIG. 1 of a device according to a second embodiment;

FIG. 4 is a view in larger scale of the detail IV in FIG. 3;

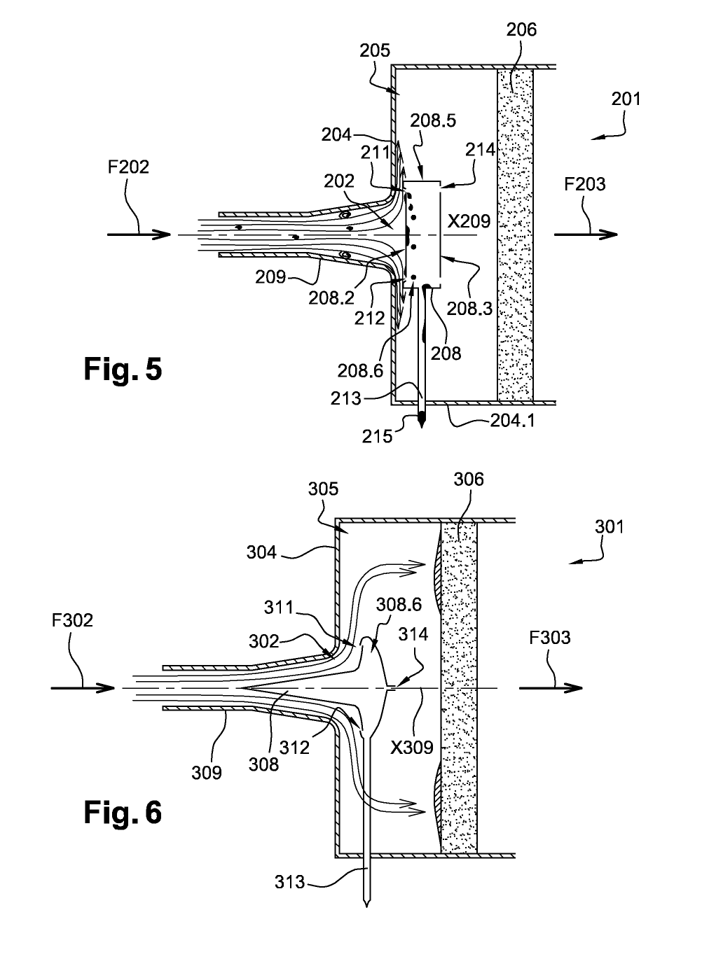

FIG. 5 is a view similar to FIG. 1 of part of a device according to a third embodiment;

FIG. 6 is a view similar to FIG. 1 of part of a device according to a fourth embodiment;

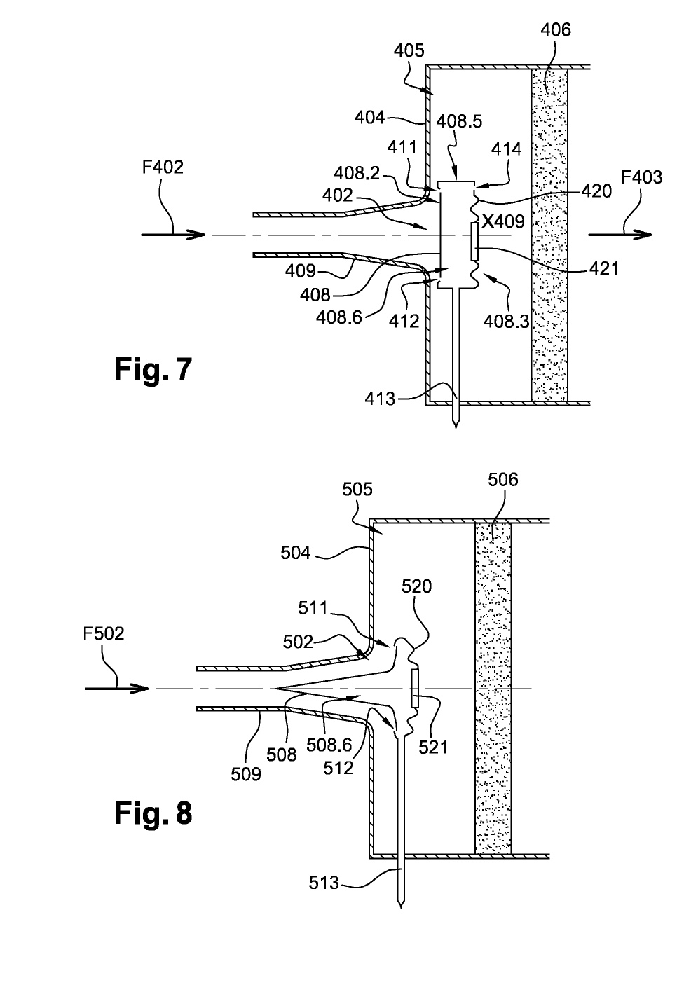

FIG. 7 is a view similar to FIG. 1 of part of a device according to a fifth embodiment; and

FIG. 8 is a view similar to FIG. 1 of part of a device according to a sixth embodiment.

### DETAILED DESCRIPTION

FIGS. 1 and 2 illustrate a filtering device 1 which comprises an inlet orifice 2 and an outlet orifice 3. The filtering device 1 has the function, in particular, of filtering a flow of air in an air intake line, not shown, of an internal combustion engine, not shown.

The inlet orifice 2 is designed for the passage of a flow of dirty air, which is represented by the symbol of an arrow F2 in FIGS. 1 and 2 and which may be laden with solid and/or liquid particles. In the example of FIGS. 1 and 2, the inlet orifice 2 is generally disk-shaped.

During operation, the inlet orifice 2 is connected to a dirty air duct, not shown, which forms part of the air intake line and which is supplied with air from outside the vehicle. The solid particles contained in the dirty air may be of any type, for example of the metal, organic, mineral type, etc. The liquid particles contained in the dirty air are generally rainwater drawn in by the internal combustion engine during operation. However, the liquid particles may be of any type.

In the present application, the verbs “to connect”, “to supply”, “to join”, “to couple” and the derivatives thereof refer to the fluidic communication, i.e. the flow of a fluid, between two separate elements via a direct or indirect connection, i.e. via no component, one component or a plurality of components.

The outlet orifice 3 is designed for the passage of a flow of filtered air which is represented by the symbol of an arrow F3 in FIG. 1. In the example of FIGS. 1 and 2, the outlet orifice 3 is generally disk-shaped.

During operation, the outlet orifice 3 is connected to a filtered air duct, not shown, which forms part of the air intake line and which channels the filtered air in the direction of the internal combustion engine. The filtered air generally contains quantities of solid and liquid particles which are sufficiently low so as not to damage respectively the internal combustion engine and a sensor arranged in the air intake line to measure the flow rate of air entering the internal combustion engine.

The filtering device 1 also comprises a housing 4. In the example of FIGS. 1 and 2, the shape of the housing 4 is generally parallelepipedal. Alternatively, the housing may have a cylindrical shape or any other shape determined, in particular, by the space restrictions in the engine compartment. The shape and the dimensions of the housing are defined as a function of the intended use, in particular as a function of the space restrictions in the vehicle provided with the filtering device.

The housing 4 comprises, on the one hand, an inlet compartment 5 into which the inlet orifice 2 opens and, on the other hand, a filtering element 6. In the example of FIGS. 1 and 2, the filtering element 6 is formed by a filter cartridge composed of porous media.

The filtering element 6 is arranged in the housing 4 between the inlet compartment 5 and the outlet orifice 2 so as to filter the flow of air which flows into the housing 4 from the inlet orifice 2 to the outlet orifice 3. The filtering element 6 has an upstream filtering surface 6.2 and a downstream filtering surface 6.3. During operation, the air enters the filtering element 6 via the upstream filtering surface 6.2 and exits the filtering element 6 via the downstream filtering surface 6.3.

To this end, the filtering element 6 in this case has a shape which is complementary to the walls defining the housing 4. In this case, the filtering element 6 may thus have a shape which is generally parallelepipedal. Moreover, the filtering element 6 is in this case arranged so as to partition or compartmentalize the housing 4 into the inlet compartment 5 and an outlet compartment 7. In other words, when a flow of air flows from the inlet orifice 2 to the outlet orifice 3, said flow of air passes through the filtering element 6.

The filtering device 1 comprises a deflector 8 which is arranged in the inlet compartment 5 and opposite the inlet orifice 2 so as to deflect the flow of dirty air F2 penetrating the inlet compartment 5. In the example of FIGS. 1 and 2, the deflector 8 is arranged parallel to the inlet orifice 2 and generally has the shape of a planar disk. Such a deflector has a shape determined, in particular, as a function of the shape of the housing and the geometry of the cartridge.

On the side of the inlet orifice 2, the deflector 8 has an upstream surface 8.2 which is generally planar. On the side of the filtering element 6, the deflector 8 has a downstream surface 8.3 which is generally planar.

Moreover, the surface area of the greatest cross section of the deflector 8, measured substantially parallel to the inlet orifice 2, for example parallel to the plane of the upstream surface 8.2, is greater than the passage cross section defined by the inlet orifice 2. In the example of FIGS. 1 and 2, the deflector 8 has a uniform cross section; thus the greatest cross section of the deflector 8 corresponds, for example, to the upstream surface 8.2.

In other words, as the inlet orifice 2 and the deflector 8 have disk shapes, the diameter D8 of the deflector 8 is greater than the diameter D2 of the inlet orifice 2.

Thus, the deflector 8 masks the inlet orifice 2 to an observer positioned in front of the inlet orifice 2 between the deflector 8 and the filtering element 6. In other words, projected in a plane perpendicular to the principal direction of the flow of dirty air F2 passing through the inlet orifice 2, the surface area of the deflector 8 is greater than the surface area of the inlet orifice 2.

Moreover, a deflection ratio L/D is in this case approximately 0.2, where:
L is the distance L2.8 between the inlet orifice and said greater cross section of the deflector 8;
D is a transverse dimension of the inlet orifice 2, in this case the diameter D2.

In the embodiment illustrated by FIGS. 1 and 2, the deflection ratio may preferably be between 0.1 and 0.3.

Such a deflection ratio makes it possible to ensure that the deflector 8 deflects all the lines of the flow of dirty air F2 which reduces the speeds of said flow of air in the inlet compartment 5 and in the region of the filtering element 6. In FIGS. 1 and 2, the lines of the flow of dirty air F2 in the housing 4 are represented by curved arrows meandering between the inlet orifice 2 and the filtering element 6.

The filtering device 1 also comprises an inlet conduit 9 which opens into the housing 4 at the inlet orifice 2. The inlet conduit 9 has a shape diverging in the direction of flow of the flow of dirty air F2.

In the example of FIGS. 1 and 2, the diverging shape of the inlet conduit 9 is frustoconical. The axis of symmetry X9 of the inlet conduit 9 substantially determines the principal direction of the flow of dirty air F2 via the inlet orifice 2.

Moreover, the inlet conduit 9 is arranged substantially in front of a central region 6.4 of the upstream filtering surface 6.2 of the filtering element 6. In other words, the projection of the inlet orifice 2 on the filtering element 6 and along the axis of symmetry X9 is inscribed within the central region 6.4.

During operation, the deflector 8 permits the air speeds to be reduced in the inlet compartment 5 and in the vicinity of the filtering element 6. Moreover, the deflector 8 makes it possible to avoid or limit the appearance or the volume of burbling 10 in the flow of air in the inlet conduit 9 upstream of the inlet orifice 2.

FIGS. 3 and 4 illustrate a filtering device 101 according to a second embodiment of the invention. Insofar as the filtering device 101 is similar to the filtering device 1, the description of the filtering device 1 provided above in relation to FIGS. 1 and 2 may be transferred to the filtering device 101, with the exception of the notable differences mentioned below.

A component of the filtering device 101 which is identical or corresponds by its structure or by its function to a component of the filtering device 1 bears the same reference numeral increased by 100. One can thus define an inlet orifice 102, a flow of dirty air F102, an outlet orifice 103, a flow of filtered air F103, a housing 104 with an inlet compartment 105 and a filtering element 106, an outlet compartment 107, a deflector 108 and an inlet conduit 109 with an axis of symmetry X109.

The filtering device 101 differs from the filtering device 1, in particular, in that the deflector 108 has approximately the shape of a nail.

The deflector 108 comprises an upstream portion 108.2 which generally has the shape of a cone and which extends wholly or partially into the inlet conduit 102. The axis of the cone forming the upstream portion 108.2 is in this case coaxial with the principal direction of the flow of dirty air F102 in the inlet conduit 102. The cone forming the upstream portion 108.2 has a half-angle at the apex A108.2 which is less than 7 angular degrees. In FIG. 4, which is not to scale, the half-angle at the apex A108.2 has been intentionally increased to make FIG. 4 more legible.

The deflector 108 also comprises a downstream portion 108.3 which extends into the inlet compartment 105 and which has a greater cross section than the base of the cone forming the upstream portion 108.2, measured in a plane perpendicular to the axis of the cone, thus in a plane perpendicular to the axis of symmetry X109.

In other words, when the upstream portion 108.2 and the downstream portion 108.3 have axis-symmetrical shapes, the diameter D108.3 of the downstream portion 108.3 is greater than the diameter D108.2 of the upstream portion 108.2.

Moreover, the filtering device 101 differs from the filtering device 1, in particular, in that for the deflector 108, the deflection ratio L/D in this case is approximately 0.5, where:
L is the distance L102.108 between the inlet orifice and said greatest cross section of the deflector 108;
D is a transverse dimension of the inlet orifice 102, in this case the diameter D102.

In the embodiment illustrated by FIGS. 3 and 4, the deflection ratio may preferably range between 0.2 and 0.8.

FIG. 5 illustrates a part of a filtering device 201 according to a third embodiment of the invention. Insofar as the filtering device 201 is similar to the filtering device 1, the description of the filtering device 1 provided above in relation to FIGS. 1 and 2 may be transferred to the filtering device 201, with the exception of the notable differences mentioned below.

A component of the filtering device 201 which is identical or corresponds by its structure or by its function to a component of the filtering device 1 bears the same reference numeral increased by 200. One can thus define an inlet orifice 202, a flow of dirty air F202, a flow of filtered air F203, a housing 204 with an inlet compartment 205 and a filtering element 206, a deflector 208 and an inlet conduit 209 with an axis of symmetry X209.

The filtering device 201 differs from the filtering device 1, in particular, in that the deflector 208 has a lateral surface 208.5 which is cylindrical and which extends between the upstream surface 208.2 and the downstream surface 208.3. The generatrices of the lateral surface 208.5 are substantially parallel to the axis of symmetry X209.

The filtering device 201 differs from the filtering device 1 in that the thickness of the deflector 208 measured perpendicular to the upstream surface 208.2 is not insignificant relative to the length of the deflector 208, measured parallel to the upstream surface 208.2.

The filtering device 201 differs from the filtering device 1 in that the deflector 208 comprises:
an envelope which defines a cavity 208.6 and which has, on the side of the inlet orifice 202, two collection holes 211 and 212 which pass through the envelope so as to permit the penetration into the cavity 208.6 of droplets formed by the water contained in the flow of dirty air F202; and
a water discharge conduit 213 which is in fluidic communication with the cavity 208.6 and which extends as far as a wall 204.1 forming part of the housing 204, so as to discharge by gravity the water which has penetrated into the cavity 208.6.

In FIG. 5, water droplets and water films are shown as shaded to illustrate the flow of water in the cavity 208.6 and then in the water discharge conduit 213. The filtering device 201 is thus able to fulfill a “decantation” function.

The filtering device 201 differs from the filtering device 1 in that the deflector 208 has on the side of the filtering element 206 (downstream) a low-pressure bringing hole 214 which extends through the envelope of the deflector 208 so as to place the cavity 208.6 and the inlet compartment 205 in fluidic communication.

The low-pressure bringing hole 214 makes it possible to bring a lower pressure in the zone between the upstream surface 208.2 and the downstream surface 208.3. A calming zone is formed at least in the deflector 208.

The loss of pressure to which the flow of dirty air F202 is subjected in the inlet compartment 205 generates a difference in pressure between the collection hole 211 or 212 and the low-pressure bringing hole 214. Said difference in pressure makes it possible to create a lower pressure inside the deflector 208 between the upstream surface 208.2 and downstream surface 208.3.

Moreover, as the flow of dirty air F202 does not pass through the volume of the deflector 208, said volume forms a calming zone. Thus, by placing the deflector 208 under low pressure and in a calming zone it is possible to draw in, via the collection holes 211 and 212, the water from the flow of dirty air F202 which acts on the upstream surface 208.2.

Indeed, after entering the deflector 208, the droplets of water no longer risk being driven back by the surrounding flow of air, as in said calming zone where the air speeds are low (<3 m/s), said water droplets are no longer subjected to drag. The water is then discharged via the water discharge conduit 213.

The water discharge conduit 213 comprises a resilient non-return valve 215 or check valve. The resilient non-return valve 215 is arranged at the end of the water discharge conduit 213 which is located opposite the deflector 208. The resilient non-return valve 215 opens under the action of water pressure in the water discharge conduit 213. The water discharge thus depends on the difference between the pressures prevailing, on the one hand, in the deflector 208 and, on the other hand, outside the filtering device 201. The resilient non-return valve 215 is able to open when the pressure of the water compensates for said difference in pressure.

FIG. 6 illustrates part of a filtering device 301 according to a third embodiment of the invention. Insofar as the filtering device 301 is similar to the filtering device 201, the description of the filtering device 201 provided above in relation to FIG. 5 may be transferred to the filtering device 301, with the exception of notable differences mentioned below.

A component of the filtering device 301 which is identical or corresponds by its structure or by its function to a component of the filtering device 201 bears the same reference numeral increased by 100. One can thus define an inlet orifice 302, a flow of dirty air F302, a flow of filtered air F303, a housing 304 with an inlet compartment 305 and a filtering element 306, a deflector 308, with a cavity 308.6, an inlet conduit 309, with an axis of symmetry X309, collection holes 311 and 312, a water discharge conduit 313 and a low-pressure bringing hole 314.

The filtering device 301 differs from the filtering device 201, in particular, in that the deflector 308 has approximately the shape of a nail. For this nail shape of the deflector 308, the description of the filtering device 101 provided above in relation to FIGS. 3 and 4 may be transferred to the filtering device 301.

By means of the deflector 308, the filtering device 301 has the advantages of the filtering device 101 combined with the advantages of the filtering device 201.

FIG. 7 illustrates part of a filtering device 401 according to a fourth embodiment of the invention. Insofar as the filtering device 401 is similar to the filtering device 201, the description of the filtering device 201 provided above in relation to FIG. 5 may be transferred to the filtering device 401, with the exception of the notable differences mentioned below.

A component of the filtering device 401 which is identical or corresponds by its structure or by its function to a component of the filtering device 201 bears the same reference numeral increased by 200. One can thus define an inlet orifice 402, a flow of dirty air F402, a flow of filtered air F403, a housing 404 with an inlet compartment 405 and a filtering element 406, a deflector 408 with an upstream surface 408.2, a downstream surface 408.3 and a cavity 408.6, an inlet conduit 409 with an axis of symmetry X409, collection holes 411 and 412, a discharge conduit 413 and a low-pressure bringing hole pressure 414.

The filtering device 401 differs from the filtering device 201, in particular, in that the deflector 408 comprises a deformable membrane 420. The deformable membrane 420 is linked to the envelope of the deflector 408 substantially on the side of the filtering element 406 in the example of FIG. 7.

The deformable membrane 420 is arranged so as to define a part of the cavity 408.6. The deformable membrane 420 extends in this case over the majority of the upstream surface 408.3 of the deflector 408.

In the example of FIG. 7, the deformable membrane 420 supports a vibrating mass 421. The thickness, the surface area and the material of the deformable membrane 420 are selected so as to dampen air vibrations having frequencies ranging between 50 Hz and 150 Hz. Similarly, the weight of the vibrating mass 421 is selected so as to dampen said air vibrations.

According to an alternative, not shown, the membrane, with or without the vibrating mass, may be arranged opposite the flow of dirty air instead of being arranged opposite the filtering element. In this alternative, the collection holes are located on the side of the flow of dirty air, as in the example of FIG. 7, but on the membrane. Moreover, the, or each, low-pressure bringing hole is thus located on a downstream face turned toward the filtering element.

FIG. 8 illustrates part of a filtering device 501, according to a fifth embodiment of the invention. Insofar as the filtering device 501 is similar to the filtering device 401, the description of the filtering device 401 provided above in relation to FIG. 7 may be transferred to the filtering device 501, with the exception of the notable differences mentioned below.

A component of the filtering device 501 which is identical or corresponds by its structure or by its function to a component of the filtering device 401 bears the same reference numeral increased by 100. One can thus define an inlet orifice 502, a flow of dirty air F502, a housing 504 with an inlet compartment 505 and a filtering element 506, a deflector 508 with a cavity 508.6, an inlet conduit 509, collection holes 511 and 512, a water discharge conduit 513, a membrane 520 and a vibrating mass 521.

The filtering device 501 differs from the filtering device 401, in particular, in that the deflector 508 has approximately the shape of a nail. For this nail shape of the deflector 508, the description of the filtering device 101 provided above in relation to FIGS. 3 and 4 may be transferred to the filtering device 501.

By means of the deflector 508, the filtering device 501 has the advantages of the filtering device 101 combined with the advantages of the filtering device 401.

1. A filtering device, for filtering a flow of air in an air intake line of an internal combustion engine, the filtering device comprising:
an inlet orifice designed for the passage of a flow of dirty air laden with solid and/or liquid particles;
an outlet orifice designed for the passage of a flow of filtered air;
a housing comprising i) at least one inlet compartment into which the inlet orifice opens, and ii) at least one filter, arranged in the housing between the inlet compartment and the outlet orifice so as to filter the flow of air which flows into the housing between the inlet orifice and the outlet orifice;
wherein the filtering device further comprises a deflector arranged in the inlet compartment and opposite the inlet orifice so as to deflect the flow of dirty air penetrating into the inlet compartment.

2. The filtering device according to claim 1, in which a surface area of greatest cross section of the deflector, measured substantially parallel to the inlet orifice, is greater than a passage cross section defined by the inlet orifice.

3. The filtering device according to claim 2, in a deflection ratio (L/D) ranges between 0.05 and 1.5, where:
L is a distance between the inlet orifice and said greatest cross section of the deflector; and
D is a transverse dimension of the inlet orifice.

4. The filtering device according to claim 1, in which the deflector comprises:
an envelope which defines a cavity and which has, on a side of the inlet orifice, at least one collection hole extending through the envelope so as to permit penetration into the cavity of droplets formed by water contained in the flow of dirty air; and
a water discharge conduit which is in fluidic communication with the cavity and which extends at least as far as a wall forming part of the housing, so as to discharge by gravity the water which has penetrated into the cavity.

5. The filtering device according to claim 4, in which the deflector has, on a side of the filtering element, at least one low-pressure bringing hole which extends through the envelope so as to place in fluidic communication the cavity and a calming zone of the housing, said calming zone extending at least into the deflector.

6. The filtering device according to claim 4, in which the deflector comprises a deformable membrane which is linked to the envelope and which is arranged so as to define a part of the cavity, the deformable membrane supporting a vibrating mass.

7. The filtering device according to claim 6, in which a thickness, surface area and material of the deformable membrane are selected so as to dampen the air vibrations which have a frequency ranging between 30 Hz and 250 Hz.

8. The filtering device according to claim 6, in which the deformable membrane is composed of a viscoelastic material which is preferably selected from the group consisting of elastomers.

9. The filtering device according to claim 1, further comprising an inlet conduit opening into the housing on the inlet orifice, the inlet conduit having a frustoconical shape which diverges according to a direction of flow of the flow of dirty air, the diverging shape being preferably frustoconical.

10. The filtering device according to claim 9, in which the inlet conduit is arranged substantially in front of a central region of an upstream surface of the filtering element.

11. The filtering device according to claim 9, in which the deflector comprises:
an upstream portion which generally has a shape of a cone and which extends wholly or partially into the inlet conduit, an axis of the cone preferably being substantially parallel or coaxial with a principal direction of the flow of dirty air in the inlet conduit; and
a downstream portion which extends into the inlet compartment and which has a greater cross section than a base of the cone measured in a plane perpendicular to an axis of the cone.

12. The filtering device according to claim 11, in which the cone has a half-angle at an apex which is less than or equal to 7 angular degrees.

13. The filtering device according to claim 1, in which the deflector has, i) on a side of the inlet orifice, an upstream surface which is generally planar, and ii) on a side of the filtering element, a downstream surface which is generally planar, the deflector having a lateral surface which is cylindrical and which extends between the upstream surface and the downstream surface.

14. The filtering device according to claim 13 in which the shape of the deflector is generally planar.

15. The filtering device according to claim 13, in which a thickness of the deflector, measured perpendicular to said upstream surface (208.2), is not insignificant relative to a length of the deflector measured parallel to said upstream surface.
